(19) United States
(12) Patent Application Publication
(10) Pub. No.: US 2024/0253870 A1
(43) Pub. Date: Aug. 1, 2024

(54) CORNER LATCH COOLER

(71) Applicant: The Coleman Company, Inc., Wichita, KS (US)

(72) Inventors: Adam Luedke, Grand Rapids, MI (US); Zachary Hafner, Kalamazoo, MI (US); Stephen C. Pennington, Kalamazoo, MI (US); Mark Elliott, Newton, KS (US)

(21) Appl. No.: 18/564,651

(22) PCT Filed: Jun. 7, 2022
(86) PCT No.: PCT/US2022/072791

§ 371 Date: Nov. 28, 2023

Related U.S. Application Data
(60) Provisional application No. 63/208,608, filed on Jun. 9, 2021.

(51) Int. Cl. B65D 43/22; B62B 1/24; B65D 25/28; B65D 43/16; B65D 55/14; B65D 81/38; E05C 19/08; F25D 3/08

(52) U.S. Cl. CPC B65D 43/22; B65D 25/2841; B65D 43/163; B65D 55/14; B65D 81/3825; E05C 19/08; F25D 3/08; B62B 1/24; B62B 2204/06

(57) ABSTRACT

A cooler is provided having latches secure a lid to a body of the cooler. The latches are affixed to corner portions the lid and the body. The corner portions may be recessed such that the latches do not protrude outside the footprint of the body of the cooler.

### CROSS-REFERENCE TO RELATED APPLICATIONS

This Application claims priority to U.S. Provisional Patent Application Ser. No. 63/208,608, filed on Jun. 9, 2021, entitled “CORNER LATCH COOLER,” currently pending, the entire disclosure of which is incorporated herein by reference.

### FIELD OF INVENTION

The present invention relates generally to coolers for chilling beverages, and more particularly to beverage coolers having lids secured with latches.

### BACKGROUND OF INVENTION

It is challenging for consumers to procure cold beverages while they are camping, hiking, or otherwise outdoors. Buying a cold beverage from a store or vending machine may not be feasible, and it may be inconvenient for the consumers to return home to obtain a cold beverage. Thus, consumers often use insulated coolers to maintain access to cold beverages when they are outside. In some cases, consumers may add ice to the beverage-filled coolers to keep the beverages cold for longer periods of time.

Oftentimes, the lids of insulated coolers are secured shut with a single latch. The latch is typically located near a middle portion of the cooler's front surface. The latch secures the lid in place and protects the items within the cooler from spilling out if the cooler is tipped over. Also, the latch may help the cooler maintain a relatively constant internal temperature by sealing the cooler's interior from the external environment. When consumers wish to open the cooler, they may open the latch, lift the cooler's lid, and then access the items stored within the cooler.

In certain situations, a single latch disposed in the middle portion of the cooler's front surface may not be ideal. First, the latch may open if it is bumped while the cooler is being transported. If the latch is open, the contents contained within the cooler may spill, causing great inconvenience to the consumer. Second, the latch typically protrudes outside of the footprint defined by the cooler's body. This makes it difficult to secure the cooler against a flat surface (such as a sidewall of a vehicle's trunk) because the front surface of the cooler cannot be placed flush against the flat surface. Finally, the handles that consumers use to carry the cooler are far away from the latch, as they are typically affixed to the side surfaces of the cooler. The distance between the latch and the handles forces the consumers to exert extra effort in opening the cooler, since they must reach across the cooler to open the latch after letting go of the handles.

### SUMMARY OF INVENTION

The cooler provided by the present disclosure seeks to overcome many of the shortcomings and limitations of the prior art devices discussed above. The present disclosure includes several embodiments of a corner latch cooler that may be used to transport beverages, food, and/or other items and help the items contained within the cooler maintain a relatively constant temperature for extended periods of time.

The corner latch cooler includes a body and a lid. The lid may be secured in a closed position by one or more latches that may be affixed to the cooler. The one or more latches may each be comprised of a latch arm and a hook, although the use of other types of latches (e.g. cam latches, compression latches, and sliding latches) are foreseeable. The latch arm may be rotatably connected to a corner portion of the lid and the hook may be affixed to an adjacent corner portion of the body. To secure the lid, a latch of the one or more latches may be placed in a first position by rotating the latch arm downwardly towards the hook and placing the hook through a slot in the latch arm. In this configuration, the hook abuts the latch arm, which may prevent the lid from being displaced upwardly. Thus, one or more latches in the first position may help secure the lid against inadvertent or accidental opening. Further, the hook may have an aperture through which a lock can be inserted. Using the lock in conjunction with the one or more latches may help reduce the likelihood that contents within the cooler are stolen.

To open the cooler, the one or more latches may be placed in a second position. The user may do so by rotating the latch arms upwardly and away from the body of the cooler. When the one or more latches are in the second position, the hooks may be withdrawn from within the slots such that the latch arms and the hooks no longer abut the latch arms. Once the one or more latches are in the second position, the user may lift the lid and access the interior of the cooler.

Finally, the corners of the lid and body to which the one or more latches are affixed may be angled or recessed such that the one or more latches do not protrude outside of the body's footprint. This may assist help the user to secure the cooler against a flat surface, thus easing transport and storage of the cooler.

These and other aspects and advantages of the present invention will become apparent to those skilled in the art after considering the following detailed description in connection with the accompanying drawings.

### BRIEF DESCRIPTION OF DRAWINGS

FIG. 1 is an isometric view of an embodiment of a corner latch cooler constructed according to the teachings hereof,

FIG. 2 is a side isometric view of a lock inserted into a latch of a corner latch cooler;

FIG. 3 is a side isometric view of the corner latch cooler of FIG. 2 with a latch arm removed;

FIG. 4 is a partial isometric view of the corner latch cooler of FIG. 1 with a lid in the open position; and

FIG. 5 is an isometric view of a second embodiment of the corner latch cooler.

While the disclosure is susceptible to various modifications and alternative forms, a specific embodiment thereof is shown by way of example in the drawings and will herein be described in detail. It should be understood, however, that the drawings and detailed description presented herein are not intended to limit the disclosure to the particular embodiment disclosed, but to the contrary, the intention is to cover all modifications, equivalents, and alternatives falling within the spirit and scope of the present disclosure as defined by the appended claims.

### DETAILED DESCRIPTION

The disclosure will now be described with reference to the drawing figures, in which like reference numerals refer to like parts throughout. For purposes of clarity in illustrating the characteristics of the present invention, proportional relationships of the elements have not necessarily been maintained in the drawing figures.

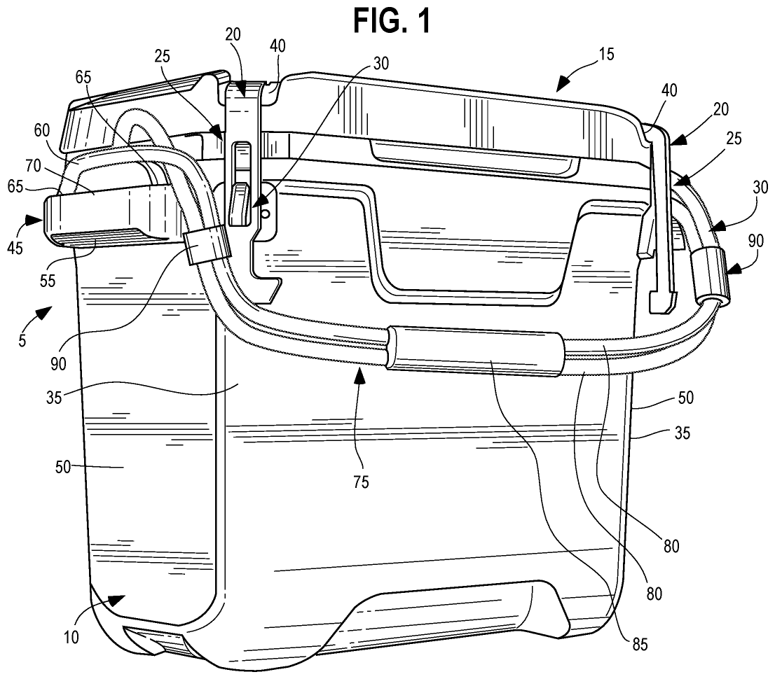

FIG. 1 illustrates a corner latch cooler 5 (hereinafter “cooler 5”) constructed to hold beverages, food items, or other objects. The cooler 5 may be made of a durable insulating material, e.g. plastic, that is suitable for helping the cooler maintain a relatively constant internal temperature. The cooler 5 may have a body 10 formed in the shape of a generally rectangular prism with rounded corners and an interior portion (not illustrated) suitable for storing beverages and/or other items. In alternative embodiments, the body 10 may take on a nearly limitless number of known and reasonably foreseeable alternative shapes and constructions. The volume of the cooler 5 may vary, but in one embodiment may be as small as 28 quarts, although it is understood that the cooler 5 may have a smaller or larger volume. For example, the internal volume of the cooler 5 can be about 28 quarts, about 55 quarts, about 65 quarts, or about 100 quarts.

A lid 15 may be hingedly affixed to the body 10 such that when it is rotated about a hinge axis, the lid 15 opens and closes, thereby allowing access to the internal volume of the cooler 5. The lid 15 may also be formed in the shape of a rectangular prism with rounded corners, although other shapes are foreseeable. Also, the lid 15 may be substantially the same size as, or slightly larger, than the body 10. The lid 15 may be placed in an open position by rotating the lid 15 upwardly and away from the body 10. Placing the lid 15 in the open position may allow a user to place items into the body 10. The lid 15 may also be placed in a closed position to isolate the interior portion of the body 10 from the outside environment, which may help the cooler 5 maintain a relatively constant internal temperature. In alternative embodiments, the lid 15 may not be affixed to the body 10. Instead, the lid 15 may simply be set on top of the body 10 or the lid 15 may be received into the body 10 and secured via a friction fit. In these embodiments, the interior portion of the body 10 may still be accessed by removing the lid 15 from the body 10.

The lid 15 may be secured in the closed position by latches 20. The latches 20 may be constructed of a lightweight, durable material as would be appreciated by those skilled in the art, such as plastic. When the latch 20 is in a first position, as illustrated, a latch arm 25 may be engaged with a hook 30. When the latch 20 is in the first position, the hook 30 may prevent upwards motion of the latch arm 25, which in turn may help keep the lid 15 in the closed position by preventing upwards motion of the lid 15. If a user wishes to open the cooler 5, the user may place the latch 20 in a second position such that the hook 30 does not engage the latch arm 25. To place the latch 20 in the second position, the user may rotate the latch arm 25 upwardly and away from the body 10. Once the latches 20 are in the second position, the user may open the lid 15 to access the items stored within the body 10.

The latches 20 may be affixed to corner portions 35, 40 of the body 10 and the lid 15, respectively. The corner portions 35, 40 may be angled relative to sides 50, such that the corner portions 35, 40 are recessed from what would have been the footprint of the cooler 5 were the sides 50 to meet at a single vertex. Thus, the latches 20 do not protrude outside of such footprint of the cooler 5. In the illustrated embodiment, two latches 20 are affixed to the corner portions 35, 40 of the cooler 5. In alternative embodiments, more or fewer latches 20 may be affixed to the cooler 5. For example, the cooler 5 can include one, two, three, four, five, or more latches 20 affixed to various portions thereof, and typically affixed to the corner portions 35, 40.

One or more handles 45 may be affixed to the cooler 5 to help a user carry the cooler 5. In the illustrated embodiment, there are two handles 45 affixed to sides 50 of the cooler 5 (though only one side 50 and handle 45 are visible because of the configuration of the cooler 5 in the illustrated embodiment), although in other embodiments the handle 45 may be affixed elsewhere on the cooler 5. The handle 45 may be formed substantially in the shape of a rectangular cuboid with thin sidewalls and an opening 55, although other shapes are foreseeable. The opening 55 may allow for the user to insert his or her fingers into the handle 45 so that the user may lift the cooler 5 upwards and off its resting surface. In the illustrated embodiment, the opening 55 is defined by the bottom surface of the handle 45, although it is foreseen that the opening 55 could form a channel passing through (i.e., defined by) both the bottom and top surfaces of the handle 45.

The handle 45 may also have a rope 60 composed of a flexible, lightweight material (such as nylon). The rope 60 may be affixed to the handle 45 such that it forms an open u-shape. The user may insert his or her hand under the rope 60 and lift upwards when the user desires to carry the cooler 5. The ends (not illustrated) of the rope 60 may be affixed to the handle 45 in a number of ways including by glue or, as illustrated, by being placed through apertures 65 that extend through a top surface 70 of the handle 45. The ends of the rope 60 may have a larger diameter than the diameter of the apertures 65 such that the ends of the rope 60 are retained within the handle 45. To achieve this, the ends of the rope 60 may be knotted, affixed with a cap, or otherwise equipped with a bulbous end as would be appreciated by those skilled in the art.

In addition, the cooler 5 may have a strap 75 that may allow the user to lift the cooler off the ground and/or carry the cooler. The strap 75 may be placed over, for example, the user's arm or shoulder to help the user carry the cooler 5. The strap 75 may also allow the user to keep his or her hands free while carrying the cooler 5. The strap 75 may be composed of a flexible, lightweight material (such as nylon) and may be formed in one piece. The strap 75 may be attached to the cooler 5 by looping the strap 75 through the rope 60 of the handles 45. In other embodiments, the strap 75 may be affixed to the handle 45, to the sides 50, or to other portions of the body 10 through various attachment mechanisms as would be appreciated by those skilled in the art. In other embodiments, the strap 75 and the rope 60 are integrally formed with one another.

The strap 75 may have two roped portions 80. By having two or more roped portions 80, the strap 75 may be able to support greater weight and may provide more stability for the user when the cooler 5 is being carried as compared to a cooler with one rope portion 80. In alternative embodiments, the strap 75 may be composed of more or fewer rope portions 80.

Furthermore, the strap 75 may have a sleeve 85 that is formed in the shape of an open cylinder and through which the strap 75 may be inserted. The sleeve 85 may be composed of a soft, rubber-like material, although other compositions would be appreciated by those skilled in the art. The sleeve 85 may assist the user in gripping the strap 75 or may provide comfort for the user when the sleeve 85 is placed over the user's arm or shoulder as the cooler is being carried. Finally, sleeves 90 may help ensure that the two portions 80 do not become tangled with each other as the cooler 5 is being stored or transported. The sleeves 90 may be formed in the shape of an open cylinder through which the portions 80 may be inserted. The sleeves 90 may be composed of a durable, rubber-like material as would be appreciated by those skilled in the art.

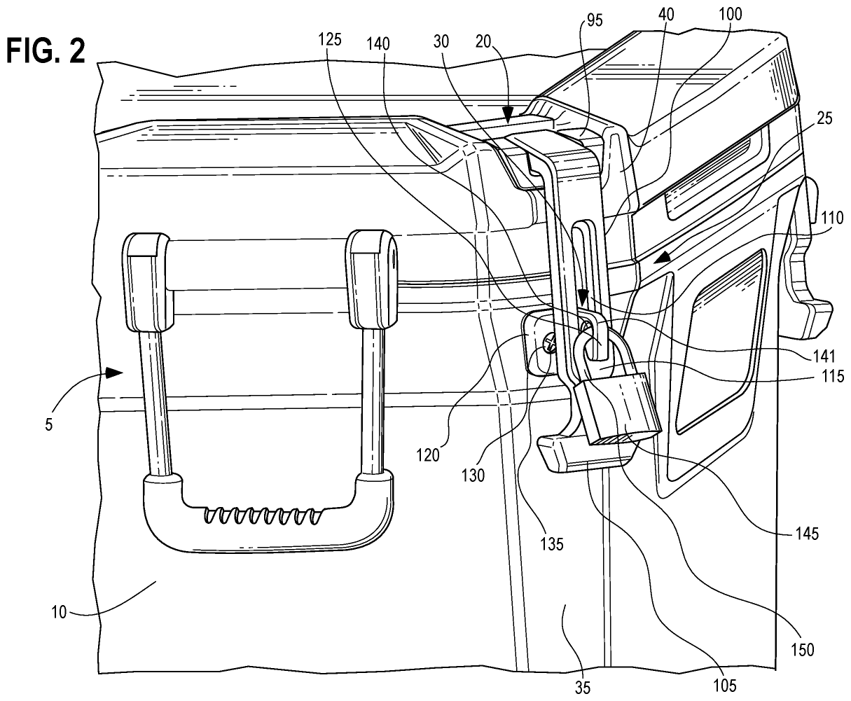

Turning to FIG. 2, the latch arm 25 may have a top portion 95 and a stem 100. The top portion 95 may extend substantially perpendicularly away from the stem 100. The top portion 95 may be affixed to the corner portion 40 of the lid 15. Also, the top portion 95 may be rotatably connected to the corner portion 40 such that the latch arm 25 may rotate downwardly and towards the body 10 and/or upwardly and away from the body 10.

The stem 100 may generally be formed in the shape of a rectangular prism with a trapezoidal-shaped knob portion 105, although other shapes are foreseeable. The knob portion 105 may help a user grip the latch 20 as the user rotates the latch arm 25. Further, the stem 100 may have a slot 110 at or near its center that extends through the body of the stem 100. The slot 110 may be in the form of a rectangle, although other shapes are foreseeable.

When the latch 20 is in the first position, the stem 100 may extend downwardly. In this position, the hook 30 may be received into the slot 110 and extend therefrom. When the hook 30 extends from the slot 110, it may abut a portion 115 of the stem 100 that is at or near the bottom of the slot 110. When the hook 30 is received into the slot 110, if the user attempts to lift the lid 15 upwardly, the hook 30 may prevent the latch arm 25 (and therefore the lid 15) from moving upwardly, thus securing the lid 15 in place.

The hook 30 may be affixed to the corner portion 35 of the body 10. The hook 30 may be composed of a plate 120 and a hook arm 125. The hook 30 may be formed in one piece, or the plate 120 and the hook arm 125 may be separate pieces that are affixed to each other. The plate 120 may be formed in the shape of a thin trapezoid (though other shapes are foreseeable) and may have one or more apertures 130 that extend through its body. The one or more apertures 130 may receive screws 135 such that the plate 120 (and thus the hook 30) may be affixed to the corner portion 35 of the cooler 5. In other embodiments, the plate 120 may not have apertures and may be secured to the corner portion 35 by glue or by another attachment means, as would be appreciated by those skilled in the art.

The hook arm 125 may have an aperture 140 that is circular and disposed of near an end 141 of the hook arm 125. The end 141, and thus the aperture 140, may extend outwardly from the slot 110, and away from the body 10, when the latch 20 is in the first position. The aperture 140 may receive a representative lock 145. The lock 145 may be used by placing a lock arm 150 through the aperture 140. The lock 145 may assist the user in securing the items within the cooler from theft when the latch 20 is in the first position. The lock used with the cooler 5 may be a keyed lock, a padlock, or other locks that are known in the art. The lock may also comprise any other locking mechanism, such as zip ties, and the like.

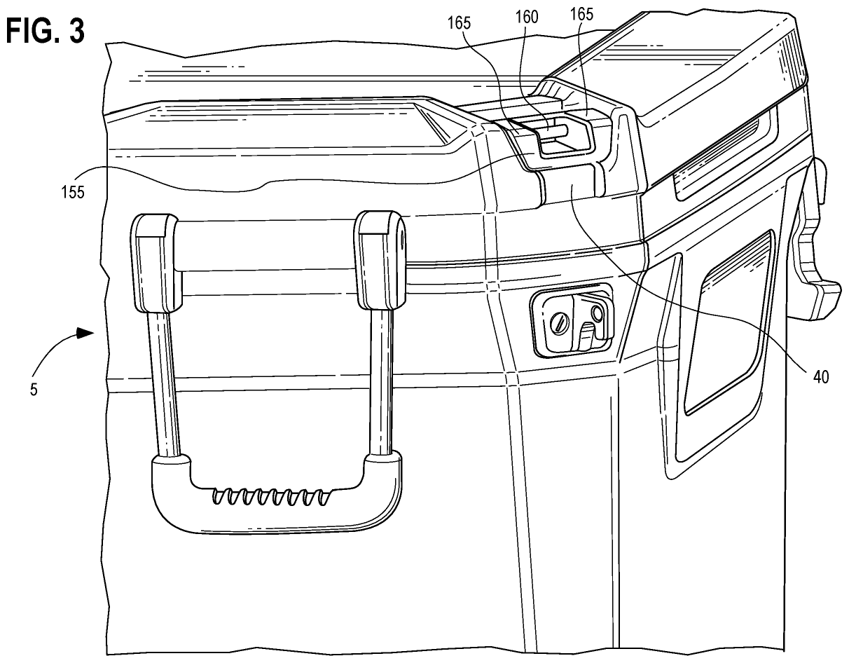

Turning to FIG. 3, the cooler 5 is illustrated with one latch arm 25 removed to illustrate additional elements of the cooler 5. The corner portion 40 may have a recessed portion 155 that forms a cavity in the corner portion 40. A cylinder 160 may be affixed to sides 165 that extend upwardly from the recessed portion 155. When the latch arm 25 is affixed to the cooler 5, the top portion 95 of the latch arm 25 may be affixed to the cylinder 160 and may rotate about the cylinder 160. The top portion 95 may have a channel into which the cylinder 160 may be inserted, or it may have a gripping end into which the cylinder 160 may be inserted. It may alternatively have other attachment means that would be appreciated by those skilled in the art.

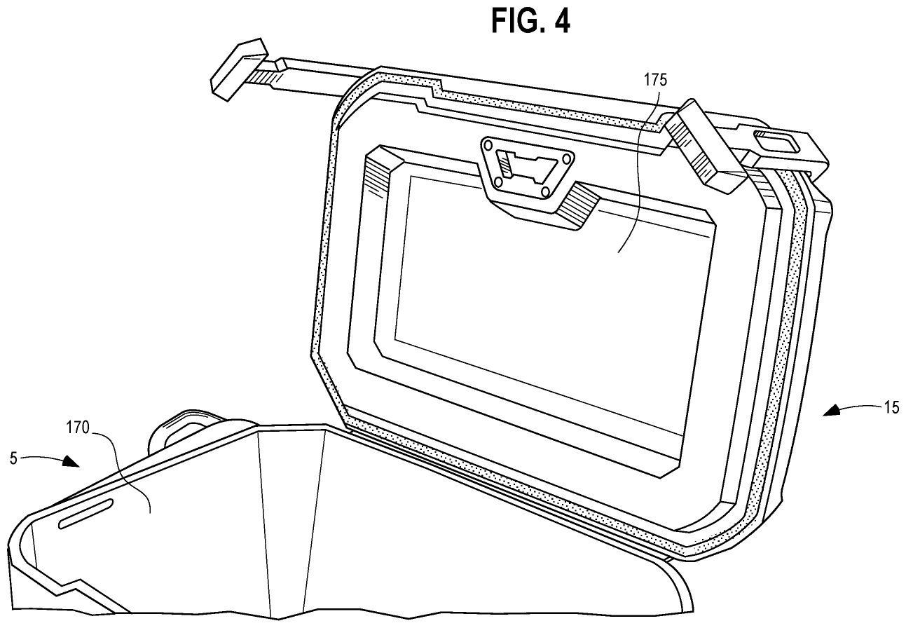

FIG. 4 illustrates the lid 15 in an open position. An interior 170 of the cooler 5 may house beverages, food, or other items when the cooler is in use. The lid 15 may have a concave portion 175 to allow the cooler 5 to store items that may be taller than the body 10 of the cooler 5.

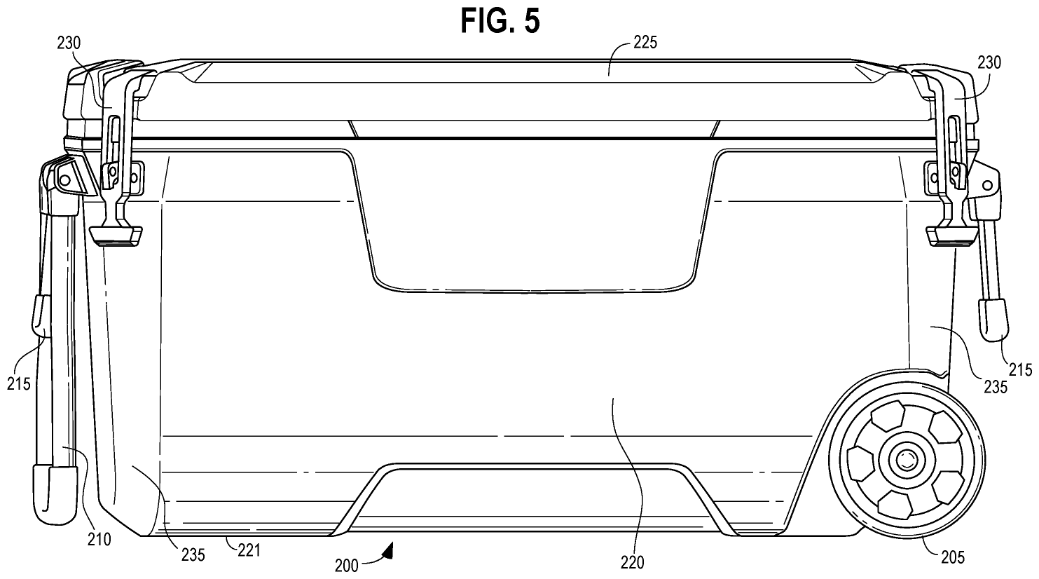

FIG. 5 illustrates an alternative embodiment of the invention, a corner latch cooler 200 (hereinafter “cooler 200”). The cooler 200, like the cooler 5, is latched at its corner portions. Unlike the cooler 5, the cooler 200 may have wheels 205 (only one of which is illustrated) and handles 210, 215 that may help the user pull the cooler 200 along the ground. The wheels 205, when rotated, may allow for the cooler 200 to be pulled along the ground with less force than a cooler without wheels. In some embodiments, the cooler may be fixed so that it does not include wheels, and in some embodiments, it may have more or fewer wheels. The handles 210, 215 may be pivotably attached to a body 220 of the cooler 200. The handles 210, 215 may be u-shaped, although other shapes are foreseeable. The handles 210, 215 may be used to pull the cooler 200 along the ground or may be used to lift the cooler off the ground when used in conjunction with an additional handle (not illustrated) that may be attached elsewhere on the cooler 200. Also, the handle 210 may be longer than the handle 215, which may allow a user to stand further away from the cooler 200 when pulling the cooler 200 as compared to when the handle 215 is used.

When the user wishes to pull the cooler 200, he or she may apply an upwards force to the handle 210 or the handle 215, lifting a bottom portion 221 of the cooler 200 off the ground. The user may then apply a pulling force to the selected handle, which may cause the wheels 205 to rotate. Alternatively, the user may simply apply a pulling force to either of the handles 210, 215 and slide the cooler 200 along the ground.

To secure a lid 225 of the cooler 200, the user may place latches 230 into a first position. The latches 230 may be affixed to a recessed corner portion 235 of the cooler 200 such that the latches 230 do not extend beyond the footprint of the cooler 200. To open the cooler 200, the user may lift rotate latches 230 upwardly and away from the cooler 200 into a second position, thereby allowing the user to lift the lid 225 upwardly. The latches 230 preferably act in a substantially similar manner to the latches 20 of the cooler 5.

As is evident from the foregoing description, certain aspects of the present invention are not limited by the particular details of the examples illustrated herein, and it is therefore contemplated that other modifications, applications, variations, or equivalents thereof, will occur to those skilled in the art. Many such changes, modifications, variations and other uses and applications of the present constructions will, however, become apparent to those skilled in the art after considering the specification and the accompanying drawings. In addition, unless mention was made above to the contrary, it should be noted that all of the accompanying drawings are not to scale. All such changes, modifications, variations and other uses in applications which do not depart from the spirit and scope of the present inventions are deemed to be covered by the inventions which are limited only by the claims which follow.

1. A cooler comprising:
a body with a recessed corner portion;
a lid with a recessed corner portion;
one or more latches that can be selectively affixed to the recessed corner portion of the lid and the recessed corner portion of the body; and
wherein when at least one latch of the one or more latches is in a closed position, the lid is secured to the body of the cooler.

2. The cooler of claim 1, wherein the latch comprises a latch arm and a hook, wherein the latch arm is selectively engageable with the hook, such that when the latch arm is engaged with the hook, the lid is secured to the body of the cooler.

3. The cooler of claim 2, wherein the latch arm is coupled to the recessed corner portion of the lid and the hook is coupled to the recessed corner portion of the body.

4. The cooler of claim 2, wherein the latch arm comprises a top portion and a stem, wherein the top portion extends substantially perpendicularly away from the stem, and wherein the top portion is coupled to the recessed corner portion of the lid.

5. The cooler of claim 4, wherein the stem defines a slot that receives the hook when the latch arm is selectively engaged with the hook.

6. The cooler of claim 4, wherein the stem comprises a first end coupled to the top portion and a second end, and wherein the second end comprises a knob portion.

7. The cooler of claim 1, further comprising at least one handle affixed to the body.

8. The cooler of claim 7, wherein the at least one handle comprises at least two handles affixed to opposing sides of the body.

9. The cooler of claim 8, further comprising a strap, wherein a first end of the strap is coupled to the first handle and a second end of the strap is coupled to the second handle.

10. A cooler comprising:
a body having:
a bottom portion;
sidewalls extending vertically upward from a perimeter of the bottom portion, each sidewall being generally perpendicular to each of its adjacent sidewalls and generally parallel to its opposing sidewall; and
corner walls, wherein a corner wall is positioned between and connecting each adjacent pair of sidewalls, wherein each corner wall is at an acute angle with respect to its connecting adjacent pair of sidewalls, each said corner wall forming a recess with respect to a footprint of the cooler;
a lid having:
a top portion;
sidewalls extending vertically downward from a perimeter of the top portion, each sidewall being generally perpendicular to each of its adjacent sidewalls and generally parallel to its opposing sidewall; and
corner walls, wherein a corner wall is positioned between and connecting each adjacent pair of sidewalls, wherein each corner wall is at an acute angle with respect to its connecting adjacent pair of sidewalls, each said corner wall forming a recess with respect to a footprint of the cooler;
at least one latch positioned in a said recess of the lid and the body; and
wherein when at least one latch of the one or more latches is in a closed position, the lid is secured to the body of the cooler.

11. The cooler of claim 10, wherein the latch comprises a latch arm and a hook, and wherein the latch arm is selectively engageable with the hook, such that when the latch arm is engaged with the hook, the lid is secured to the body of the cooler.

12. The cooler of claim 11, wherein the latch arm is coupled to the corner wall of the lid, and the hook is coupled to the corner wall of the body.

13. The cooler of claim 11, wherein the latch arm comprises a top portion and a stem, wherein the top portion extends substantially perpendicularly away from the stem, and wherein the top portion is coupled to the corner wall of the lid.

14. The cooler of claim 13, wherein the stem defines a slot that receives the hook when the latch arm is selectively engaged with the hook.

15. The cooler of claim 11, wherein the hook comprises a plate and a hook arm, and wherein the plate is coupled to the corner wall of the body and the hook arm is coupled to the plate.

16. The cooler of claim 15, wherein the hook arm defines an aperture configured to receive a lock.

17. The cooler of claim 10, wherein the recess of the corner wall of the lid defines a cavity.

18. The cooler of claim 17, further comprising a cylinder affixed within the cavity, wherein the latch comprises a latch arm coupled to and configured to rotate about the cylinder.

19. The cooler of claim 13, wherein the stem comprises a first end coupled to the top portion and a second end, and wherein the second end comprises a knob portion.

20. The cooler of claim 10, further comprising:
at least two handles affixed to opposing sidewalls of the body; and
a strap;
wherein a first end of the strap is coupled to the first handle and a second end of the strap is coupled to the second handle.
